(19) United States
(12) Patent Application Publication
(10) Pub. No.: US 2007/0080902 A1
(43) Pub. Date: Apr. 12, 2007

(54) Plasma display device and driving method thereof

(76) Inventors: Joon-Yeon Kim, Yongin-si (KR); Hak-Cheol Yang, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/525,774

(22) Filed: Sep. 22, 2006

(30) Foreign Application Priority Data
Oct. 11, 2005 (KR) 10-2005-0095369

(51) Int. Cl. G09G 3/28

(52) U.S. Cl. 345/67

(57) ABSTRACT

In a plasma display device, each of a plurality of scan lines is shared by a corresponding one of first display lines and a corresponding one of second display lines, and a plurality of address lines are formed in a direction crossing the plurality of scan lines. A plurality of first discharge cells are defined by the first display lines and the address lines, and a plurality of second discharge cells are defined by the second display lines and the address lines. A first turn-on cell is selected among the first discharge cells during a first period of an address period, and a second turn-on cell is selected among the second discharge cells during a second period of the address period. In addition, during a third period between the first and second periods of the address period, the first turn-on cell is sustain-discharged.

### CROSS-REFERENCE TO RELATED APPLICATION

This application claims priority to and the benefit of Korean Patent Application No. 10-2005-0095369 filed in the Korean Intellectual Property Office on Oct. 11, 2005, the entire content of which is incorporated herein by reference.

### BACKGROUND OF THE INVENTION

(a) Field of the Invention

The present invention relates to a plasma display device and a driving method thereof.

(b) Description of the Related Art

A plasma display device is a flat panel display that uses plasma generated by a gas discharge to display characters or images. It includes a plurality of discharge cells arranged in a matrix pattern.

One frame of the plasma display device is divided into a plurality of subfields each having a brightness weight, and each subfield includes a reset period, an address period, and a sustain period. A discharge cell to be turned on (hereinafter, referred to as a “turn-on cell”) and a discharge cell to be turned off (hereinafter, referred to as a “turn-off cell”) are selected during an address period of each subfield. The turn-on cell is sustain-discharged during a sustain period so as to display an image.

During the address period, a plurality of display lines are respectively scanned so as to select turn-on cells. Therefore, scan circuits corresponding to the number of display lines are required to sequentially scan the plurality of display lines, which increases a cost of the plasma display device.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect of the present invention provides a plasma display device for reducing the number of scan circuits and a method of driving the plasma display device.

Another aspect of the invention provides a method of driving a plasma display device, wherein the plasma display device is driven by a plurality of subfields divided from a frame, and the plasma display device includes a plurality of scan lines respectively having a plurality of first display lines and a plurality of second display lines, a plurality of address lines crossing the plurality of scan lines, a plurality of first discharge cells respectively formed by the plurality of first display lines and the plurality of address lines, and a plurality of second discharge cells respectively formed by the plurality of second display lines and the plurality of address lines. In one embodiment, a first light emitting cell is selected from among the plurality of first discharge cells during a first period of an address period, a second light emitting cell is selected from among the plurality of second discharge cells during a second period of the address period, and the first light emitting cell is sustain-discharged during a third period between the first and second periods of the address period to compensate wall charges of the plurality of second discharge cells.

Another aspect of the invention provides a plasma display device which includes a plasma display panel (PDP) and a driver. The PDP includes a plurality of scan lines respectively having first display lines and second display lines, a plurality of address lines crossing the plurality of scan lines, and a plurality of discharge cells respectively formed by the first and second display lines and the plurality of address lines. The driver selects a turn-on discharge cell from the first display line during a first period of an address period, selects the turn-on discharge cell from the second display line during a second period of the address period, sustain-discharges the turn-on discharge cell of the first display line during a third period between the first period and the second period, and compensates wall charges of the turn-on discharge cell of the second display line.

Still another aspect of the invention provides a plasma display device, comprising: a plurality of scan lines, a plurality of address electrodes crossing the scan lines, a plurality of first discharge cells defined by a plurality of first display regions and the address electrodes, a plurality of second discharge cells defined by a plurality of second display regions and the address electrodes, wherein two adjacent first and second display regions share one of the scan lines. In one embodiment, the driver is configured to: i) sequentially apply a first scan pulse to the scan lines so as to select a first turn-on cell from the first discharge cells during a first period of an address period, ii) sequentially apply a second scan pulse to the scan lines so as to select a second turn-on cell from the second discharge cells during a second period of the address period, iii) apply a first voltage to the scan lines during a third period between the first and second periods so as to sustain-discharge one of the first and second turn-on cells, and iv) alternatively apply a second voltage and a third voltage to the scan lines so as to sustain-discharge the first and second turn-on cells during a sustain period, wherein the second voltage is lower than the first voltage and the third voltage is lower than the second voltage.

### BRIEF DESCRIPTION OF THE DRAWINGS

FIG. 1 shows a schematic diagram of a plasma display device according to an exemplary embodiment of the present invention.

FIG. 2 shows a diagram representing one exemplary embodiment of an electrode arrangement of the PDP shown in FIG. 1.

FIG. 3A to FIG. 3C respectively show diagrams representing driving waveforms of the plasma display device according to one exemplary embodiment of the present invention.

FIG. 4A to FIG. 4C respectively show a diagram representing discharge cell states at two adjacent display lines.

FIG. 5A to FIG. 5F respectively show diagrams representing wall charge states on a discharge cell in respective periods of FIG. 3A to FIG. 3C.

FIG. 6 shows a diagram representing another exemplary embodiment of an electrode arrangement of the PDP shown in FIG. 1.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, wall charges mentioned in the following description mean charges formed and accumulated on a wall (e.g., a dielectric layer) close to an electrode of a discharge cell. A wall charge will be described as being “formed” or “accumulated” on the electrode, although the wall charges do not actually touch the electrodes. Further, a wall voltage means a potential difference formed on the wall of the discharge cell by the wall charge.

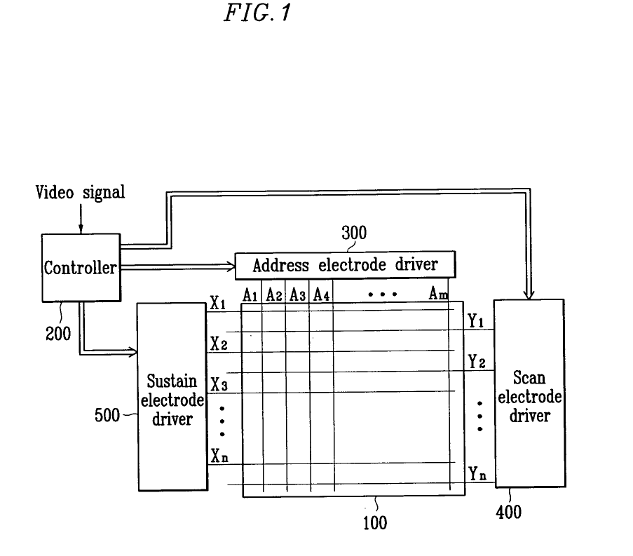

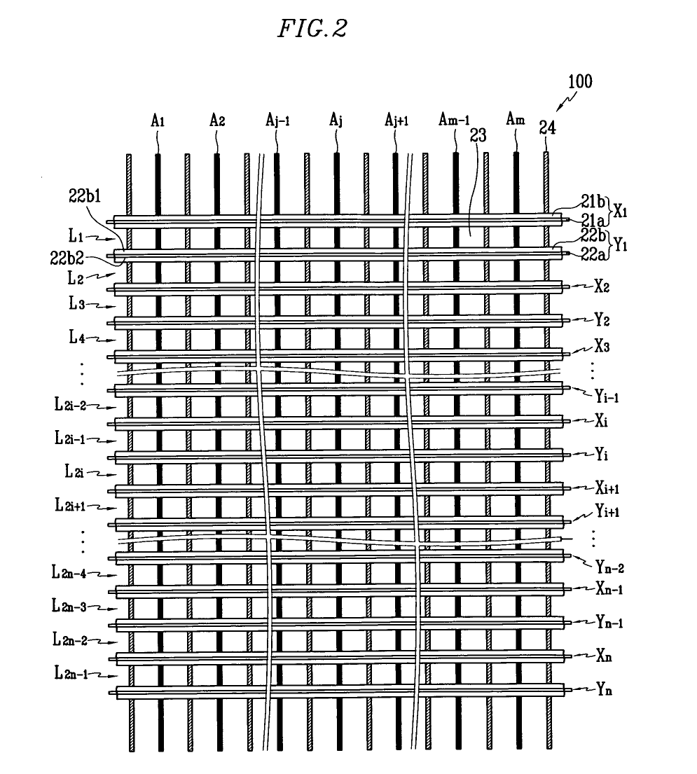

A plasma display device according to an exemplary embodiment of the present invention will be described with reference to FIG. 1 and FIG. 2.

FIG. 1 shows a schematic diagram of the plasma display device according to the exemplary embodiment of the present invention.

As shown in FIG. 1, the plasma display device includes a plasma display panel (PDP) 100, a controller 200, an address electrode driver 300, a scan electrode driver 400, and a sustain electrode driver 500.

The PDP 100 includes a plurality of address (A) electrodes A₁ to Aₘ, extending in a column direction, a plurality of sustain (X) electrodes X₁ to Xₙ extending in a row direction, and a plurality of scan (Y) electrodes Y₁ to Yₙ also extending in the row direction.

The controller 200 receives an external video signal and outputs an A electrode driving control signal, an X electrode driving control signal, and a Y electrode driving control signal. In addition, the controller 200 divides a frame into a plurality of subfields respectively having a weight. Further, the controller 200 controls the sustain electrode driver 500 to drive a first group including odd-numbered X electrodes and a second group including even-numbered X electrodes separately. In another embodiment, the first group may include even-numbered X electrodes, and the second group may include odd-numbered X electrodes.

The address electrode driver 300 receives the A electrode driving control signal from the controller 200 and applies a driving voltage to the A electrodes A₁ to Aₘ.

The scan electrode driver 400 receives the Y electrode driving control signal from the controller 200 and applies a driving voltage to the Y electrodes Y₁ to Yₙ.

The sustain electrode driver 500 receives the X electrode driving control signal from controller 200 and applies a driving voltage to the X electrodes X₁ to Xₙ.

FIG. 2 shows a diagram representing one exemplary embodiment of an electrode arrangement of the PDP shown in FIG. 1.

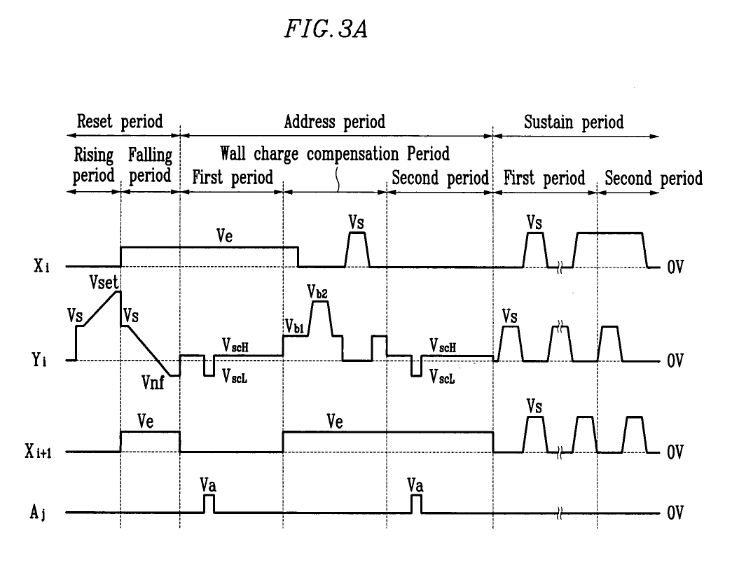

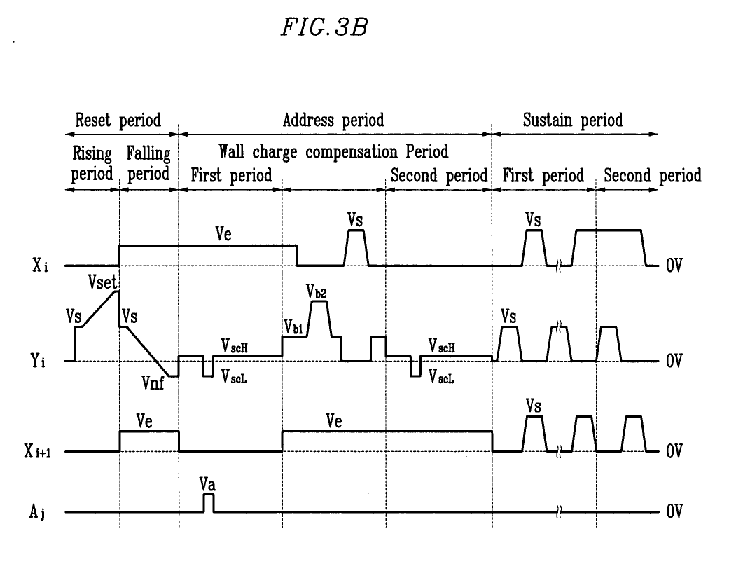

In the PDP 100, the A electrodes A₁ to Aₘ may be formed on a substrate (e.g., a rear substrate), and the X electrodes X₁ to Xₙ and the Y electrodes Y₁ to Yₙ may be formed on another substrate (e.g., a front substrate) such that the two substrates face to each other. As shown in FIG. 2, the respective X electrodes X₁ to Xₙ are alternately formed with respect to the Y electrodes Y₁ to Yₙ The Y electrodes Y₁ to Yₙ define scan lines to which a scan pulse having a scan voltage (see VscL in FIG. 3A to FIG. 3C) is applied during an address period, and the A electrodes A₁ to Aₘ define address lines to which an address pulse having an address voltage (see Va in FIG. 3A to FIG. 3C) is applied during the address period. In addition, each of display lines (display regions) L₁ to L₍₂ₙ₋₁₎ for displaying an image is defined between a corresponding one of the Y electrodes Y₁ to Yₙ and a corresponding one of the X electrodes X₁ to X₁. The display lines L₁ to L₍₂ₙ₋₁₎ include a plurality of first display lines and a plurality of second display lines. Each of the first display lines is defined by a corresponding one of the first group including the odd-numbered X electrodes X₁, X₃, . . . , and X₍ₙ₋₁₎ and a corresponding one of the Y electrodes Y₁ to Y₁. Each of the second display lines is defined by a corresponding one of the second X electrode group including the even-numbered X electrodes X₂, X₄, . . . , and Xₙ and a corresponding one of the Y electrodes Y₁ to Yₙ. Therefore, one X electrode may define two display lines, which are respectively located at the upper side and the lower side of the X electrode, together with two adjacent Y electrodes. One Y electrode also may define two display lines, which are respectively located at the upper side and the lower side of the Y electrode, together with two adjacent X electrodes.

In addition, discharge spaces at crossing regions of the display lines L₁ to L₍₂ₙ₋₁₎ and the A electrodes A₁ to Aₘ respectively define discharge cells 23, and the discharge cells 23 are partitioned in the row direction by barrier ribs 24. The barrier ribs 24 extends in the column direction and are formed between two adjacent A electrodes. Each of the X electrodes X₁ to Xₙ includes a bus electrode 21a and a transparent electrode 21b, and each of the Y electrodes Y₁ to Y₁ also includes a bus electrode 22a and a transparent electrode 22b. The transparent electrodes 21b and 22b are respectively coupled to the bus electrodes 21a and 22a. In one embodiment, the width along the column direction of the transparent electrode 21 b or 22b may be wider than that of the bus electrode 21a or 22a. In one embodiment, the transparent electrode 21b or 22b may be formed by non-transparent materials. In one embodiment, the discharge cells 23 may be partitioned in a column direction by barrier ribs (not shown) formed on the bus electrodes 21a and 22a. Since two adjacent display lines share one of the X and Y electrodes and, the respective X and Y electrodes participate in sustain-discharging discharge cells 23 that are placed on both sides thereof.

A plurality of scan circuits (not shown) are respectively coupled to the plurality of scan lines, i.e., the Y electrodes Y₁ to Yₙ, and are formed in the scan electrode driver 400. In addition, a scan voltage (VscL in FIG. 3A) and a non-scan voltage (VscH in FIG. 3A) are selectively applied to the Y electrodes Y₁ to Yₙ by the scan circuits.

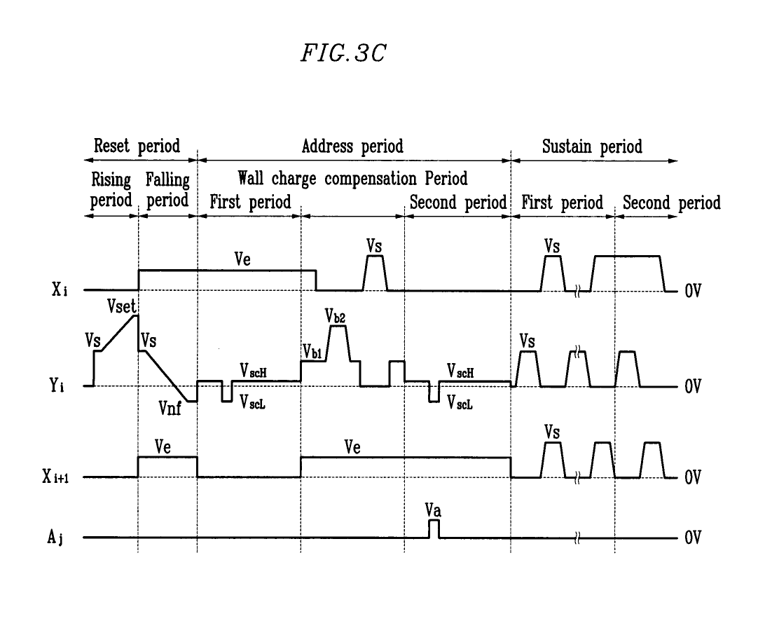

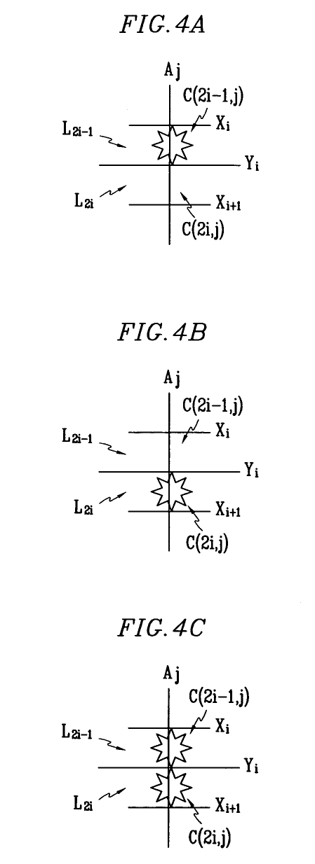

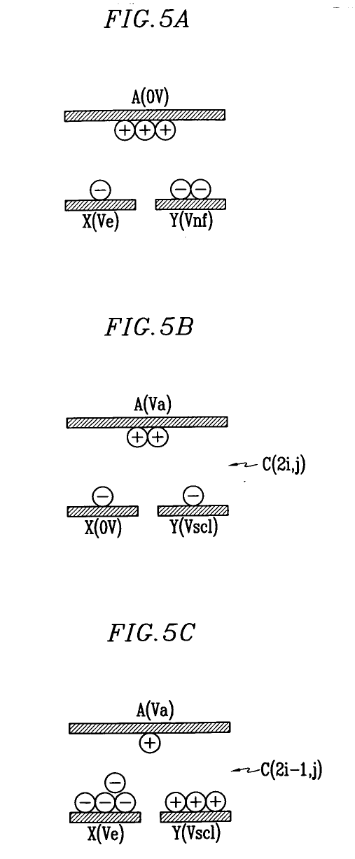

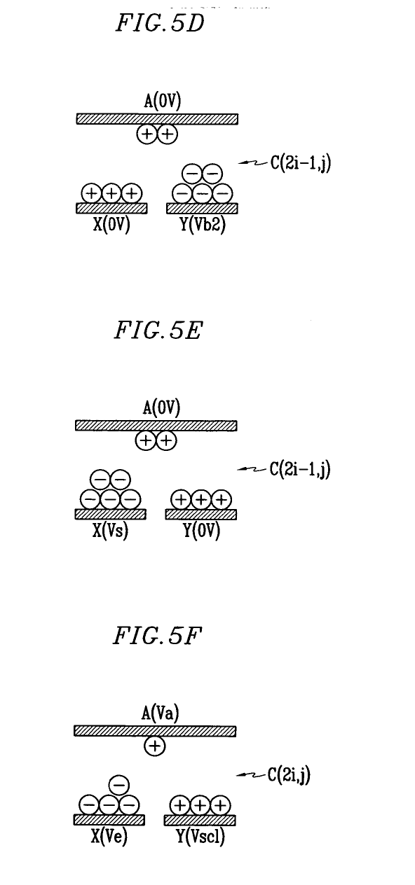

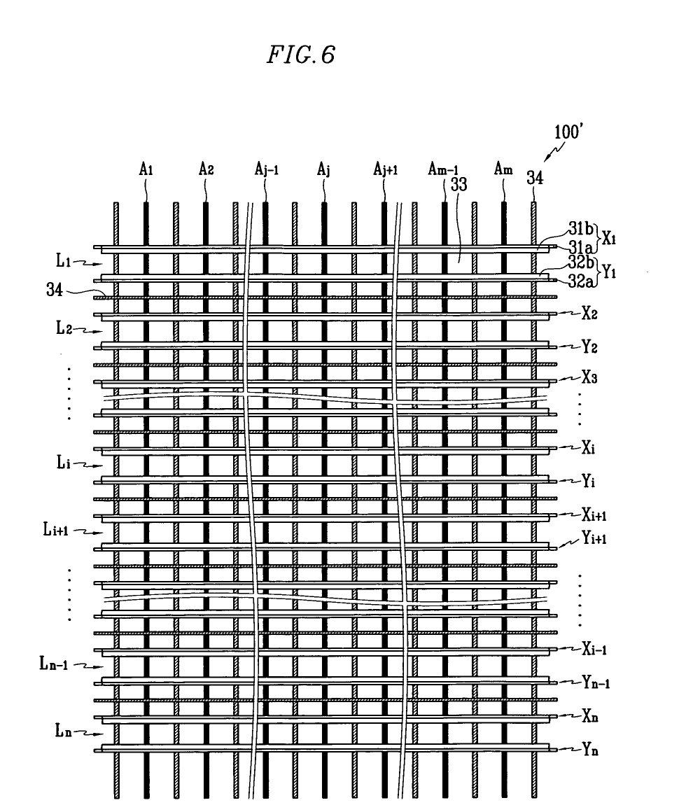

A driving method of the plasma display device according to the exemplary embodiment of the present invention will now be described with reference to FIG. 3A to FIG. 3C, FIG. 4, and FIG. 5A to FIG. 5F.

FIG. 3A to FIG. 3C respectively show diagrams representing driving waveforms of the plasma display device according to first to third exemplary embodiments of the present invention, and FIG. 4 shows a diagram representing discharge cell states at neighboring display lines. In addition, FIG. 5A to FIG. 5F respectively show diagrams representing wall charge states on the respective electrodes for respective periods.

In FIG. 3A to FIG. 3C, driving waveforms applied to two adjacent discharge cells C(2i−1, j) and C(2i, j) defined by first and second display lines L₍₂ᵢ₋₁₎ and L₂ᵢ sharing one scan line (i.e., Y electrode Yᵢ) and one address line (i.e., A electrode Aⱼ) as shown in FIG. 4 will be described. That is, the discharge cell C(2i−1, j) is defined by the X electrode Xᵢ and the Y electrode Yᵢ, forming the first display line L_{2i×1} and the A electrode Aⱼ. Furthermore, the discharge cell C(2i, j) is defined by the X electrode Xᵢ₊₁ and the Y electrode Yᵢ, forming the second display line L₂ᵢ and the A electrode Aⱼ, For convenience, it is assumed that ‘i’ is an odd number (1, 3, 5, . . . ).

Referring to FIG. 3A to FIG. 3C, an address period in a subfield includes a first period, a second period, and a wall charge compensation period provided between the first period and the second period. When the discharge cell C(2i−1, j) is selected as a turn-on cell among the two discharge cells C(2i−1, j) and C(2i, j) as shown in FIG. 4A, an address discharge is generated during the first period. In addition, when the discharge cell C(2i, j) is selected as a turn-on cell among the two discharge cells C(2i−1, j) and C(2i, j) as shown in FIG. 4B, the address discharge is generated during the second period. Further, when the two discharge cells C(2i−1, j) and C(2i, j) are selected as turn-on cells as shown in FIG. 4C, the address discharges are generated during the first and second periods.

Firstly, the driving waveform of the plasma display device when the two discharge cells C(2i−1, j) and C(2i, j) on the first and second display lines L₍₂ᵢ₋₁₎ and L₂ᵢ are selected as the turn-on cell as shown in FIG. 4C will be described with reference to FIG. 3A.

As shown in FIG. 3A, during a rising period of the reset period, a voltage at the Y electrode Yᵢ gradually increases from a Vs voltage to a Vset voltage while the reference voltage is applied to the first and second groups Xᵢ and Xᵢ₊₁ of the X electrodes. In one embodiment, the reference voltage may be a ground voltage (0V) as shown in FIG. 3A. In one embodiment, the voltage at the Y electrode may increase in a ramp pattern as shown in FIG. 3A. Then, the (−) wall charges are formed on the Y electrode Yᵢ, and the (+) wall charges are formed on the X electrodes Xᵢand Xᵢ₊₁, and the A electrode Aⱼ since weak discharges are generated 1) between the Y electrode Yᵢ and the X electrodes Xᵢ and Xᵢ₊₁, and 2) between the Y electrode Yᵢ and A electrode Aⱼ while the voltage at the Y electrode Y₁ increases.

During a falling period of the reset period, while a Ve voltage, which is higher than the reference voltage, is applied to the first and second groups Xᵢ and Xᵢ₊₁, of the X electrodes, the voltage at the Y electrode Yᵢ gradually decreases from the Vs voltage to a Vnf voltage. Then, the weak discharges are generated 1) between the Y electrode Yᵢ and the X electrodes Xᵢ and Xᵢ₊₁ and 2) between the Y electrode Yᵢ and the A electrode Aⱼ while the voltage at the Y electrode Yᵢ decreases. Furthermore, the (−) wall charges formed on the Y electrode Yᵢ and the (+) wall charges formed on the X electrodes Xᵢ and Xᵢ₊₁ and the A electrode Aⱼ as shown in FIG. 5A are eliminated, and the discharge cell is initialized to be a turn-off cell. In general, when the Vnf voltage is applied during the falling period of the reset period, a sum of 1) a wall voltage between the X electrode Xᵢ or Xᵢ₊₁ and the Y electrode Yᵢ and 2) an external voltage of (Vnf−Ve) between the Y electrodes Yᵢ and the X electrode Xᵢ or Xᵢ₊₁ is set to be a discharge firing voltage between the Y electrode Yᵢ and the X electrode Xᵢ or Xᵢ₊₁. Then, a sustain discharge error (misfiring) may be prevented in a turn-off cell on which the address discharge is not generated during the address period since the wall voltage between the Y electrode Yᵢ and the X electrode Xᵢ or Xᵢ₊₁ reaches 0V.

Subsequently, during the first period of the address period, while the reference voltage is applied to the second group Xᵢ₊₁ of the X electrodes and the Ve voltage is applied to the first group Xᵢ of the X electrodes, a scan pulse having a scan voltage VscL is sequentially applied to the Y electrodes (Y₁ to Yₙ of FIG. 1). In one embodiment, the scan voltage VscL may be set to be substantially the same as or lower than the Vnf voltage. An address voltage Va is applied to the A electrode Aⱼ passing the discharge cell C(2i−1, j) that is to be selected among the discharge cells on the first display line L₍₂ᵢ₋₁₎ formed by 1) the Y electrode Yᵢ to which the scan voltage VscL is applied and 2) the first group X₁. In addition, a VscH voltage that is higher than the scan voltage VscL is applied to the other Y electrodes to which the scan voltage VscL is not applied, and the reference voltage is applied to the A electrode of the remaining discharge cells that are not selected. Accordingly, since the address discharge is generated on the discharge cell C(2i−1, j) defined by the Y electrode Yᵢ receiving the voltage VscL, the A electrode Aⱼ receiving the voltage Va, and the X electrode X₁ receiving the voltage Ve, among the two discharge cells C(2i−1, j) and C(2i, j), the (+) wall charges are formed on a first portion of the Y electrode Yᵢ (see “22b1” in FIG. 2) and the (−) wall charges are formed on the first group Xᵢ as shown in FIG. 5C. Here, the Y electrode Yᵢ includes the first portion (22b1) and a second portion (22b2). The first portion (22b1) of the Y electrode Yᵢ is a portion which is above the bus electrode 22a and closer to the first group electrodes Xᵢ, and the second portion (22b2) of the Y electrode Yᵢ is a portion which is below the bus electrode 22a and closer to the second group electrodes Xᵢ₊₁.

During the first period, the address discharge is not generated on the discharge cell C(2i, j). However, a weak discharge may be generated between the Y electrode Yᵢ (i.e., the second portion (22b2) of the Y electrode Yᵢ) and the A electrode A₁ of the discharge cell C(2i, j) while the address discharge is generated on the discharge cell C(2i−1, j) on the first display line L₂ᵢ₋₁ during the first period. That is, the weak discharge may be generated in at least one discharge cell on the second display line, which shares the scan line and the address line with the discharge cell in which the address discharge is generated during the first period of the address period. In addition, the intensity of the weak discharge is weaker than that of the sustain discharge. Then, since (+) wall charges and (−) wall charges have been respectively formed on the A electrode Aⱼ and the second portion 22b2 of the Y electrode Yᵢ of the discharge cell C(2i, j) during the reset period as shown in FIG. 5A before the weak discharge is generated, a portion of the previously formed charges is partly eliminated by the weak discharge as shown in FIG. 5B.

Subsequently, in the wall charge compensation period, while the reference voltage is applied to the A electrode Aⱼ and the Ve voltage is applied to the first group X of the X electrodes, a Vb1 voltage, which is higher than the voltage VscH, is applied to the Y electrode Yᵢ and the Ve voltage is applied to the second group Xᵢ₊₁ of the X electrodes. Subsequently, the reference voltage is applied to the first group Xᵢ of the X electrodes, and a Vb2 voltage, which is higher than the Vb1 voltage, is applied to the Y electrode Yᵢ. In one embodiment, the Vb2 voltage may be set to be higher than the voltage Vs. In one embodiment, the Vb1 voltage may be set to be substantially the same as a voltage of (VscH−VscL) and the Vb2 voltage may be set to be substantially the same as a voltage of (Vs+(VscH−VscL)) such that the Vb1 and Vb2 voltages can be supplied without additional power sources. Then, a sustain discharge is generated on the discharge cell C(2i−1, j) having a wall charge state shown in FIG. 5C of the first display line L₍₂ᵢ₋₁₎ formed by the Vb2 voltage. As a result, the (+) wall charges are formed on the first group Xᵢ of the X electrodes and the A electrode Aⱼ , and the (−) wall charges are formed on the Y electrode Yᵢ as shown in FIG. 5D. In addition, the weak discharge is generated on the discharge cell C(2i, j) of the second display line L₂ᵢ by the Vb2 voltage and the wall voltage between the A electrode Aⱼ and the second portion (22b2) of the Y electrode Yᵢ. Since the (−) wall charges have been formed on the second portion (22b) of the Y electrode Yᵢ and the (+) wall charges have been formed on the A electrode Aⱼ as shown in FIG. 5B, the wall charge state of the discharge cell C(2i, j) on the second display line L₂ᵢ becomes equal to the wall charge state when the reset period ends as shown FIG. 5A by the weak discharge.

Subsequently, in the wall charge compensation period, the Vs voltage is applied to the first group Xᵢ of the X electrodes, and the reference voltage is applied to the Y electrode Yᵢ. Then, since the sustain discharge is generated in the discharge cell C(2i−1, j) on the first display line L₍₂ᵢ₋₁₎, the (+) wall charges are formed on the first portion (22b1) of the Y electrode Yᵢ, and the (−) wall charges are formed on the first group Xᵢ of the X electrodes as shown in FIG. 5E. Since the reference voltage is applied to the second group Xᵢ₊₁ of the X electrodes and Y electrode Yᵢ, no discharge is generated in the discharge cell C(2i, j) on the second display line L₂ᵢ. Therefore, the wall charge of the discharge cell C(2i, j) is still the same as the wall charge state when the reset period ends. Accordingly the wall charges partly eliminated from the A and Y electrodes of the discharge cell C(2i, j) on the second display line in the first period of the address period can be compensated during the wall charge compensation period.

In one embodiment, the voltage Vb2 may satisfy Equation 1 and Equation 2 in order to generate the weak discharge between the Y and A electrodes Yᵢ and Aⱼ of the discharge cell C(2i, j) on the second display line L_{2i.}
Vb2−Vw>Vf_{AY} Equation 1

where Vw is a wall voltage between the A and Y electrodes of the discharge cell in a state shown in FIG. 5B, and Vf_{AY} is a discharge firing voltage between the A and Y electrodes.
Vb2−VW<Vf_{AY} Equation 2

where VW is a wall voltage between the A and Y electrodes of the discharge cell in a state shown in FIG. 5A.

Accordingly, based on Equation 1 and Equation 2, the Vb2 voltage may be set to satisfy Equation 3.
Vf_{AY}+Vw<Vb2<Vf_{AY}+Vw Equation 3

Subsequently, during the second period of the address period, while the Ve voltage is applied to the second group Xᵢ₊₁, of the X electrodes and the reference voltage is applied to the first group Xᵢ of the electrodes , a scan pulse having the scan voltage VscL is sequentially applied to the Y electrodes (Y₁ to Yₙ of FIG. 1). The address voltage Va is applied to the A electrode Aⱼ passing the discharge cell C(2i, j) that is to be selected among the discharge cells on the second display line L₂ᵢ formed by the Y electrode Yᵢ to which the scan voltage VscL is applied and the second group Xᵢ₊₁ of the X electrodes. Then, the address discharge is generated in the discharge cell C(2i, j) on a second display line L₂ᵢ. As a result, the (+) wall charges are formed on the second portion (22b2) of the Y electrode Yᵢ, and the (−) wall charges are formed on the second group Xᵢ₊₁ of the X electrodes as shown in FIG. 5F. Since the wall charge state of the discharge cell C(2i−1, j) on the first display line L₂ᵢ₋₁ is as shown in FIG. 5E, the address discharge is not generated in the discharge cell (2i−1, j) during the second period of the address period.

Subsequently, during a first period of the sustain period, sustain pulses alternately having a high level voltage (the Vs voltage in FIG. 3A) or a low level voltage (0V in FIG. 3A) are applied to the Y electrode Yᵢ and the X electrodes Xᵢ and Xᵢ₊₁ with opposite polarity, and accordingly the sustain discharge is generated between the Y and X electrodes of the turn-on cells C(2i−1, j) and C(2i, j). These sustain pulse may be applied to all the Y electrodes (Y₁ to Yₙ of FIG. 1) and all the X electrodes (X₁ to Xₙ of FIG. 1) with opposite polarity. That is, 0V is applied to the X electrodes Xᵢ and Xᵢ₊₁, when the Vs voltage is applied to the Y electrode Yᵢ, and 0V is applied to the Y electrode Yᵢ when the Vs voltage is applied to the X electrodes Xᵢ and Xᵢ₊₁. Then, a discharge is generated between the Y electrode Yᵢ and X electrodes Xᵢ and Xᵢ₊₁, by the Vs voltage and the wall voltage formed between the Y electrode Yᵢ and X electrodes Xᵢ and Xᵢ₊₁ by the address discharge during the first and second periods of the address period. Subsequently, the sustain pulses are repeatedly applied to the Y electrode Y and X electrodes Xᵢ and Xᵢ₊₁ in proportion to the weight of a corresponding subfield.

In addition, since the sustain discharge have been performed twice in the discharge cell C(2i−1, j) on the first display line L₂ᵢ₋₁ during the wall charge compensation period, the sustain discharge is additionally performed twice in the discharge cell C(2i, j) on the second display line L₂ᵢ during a second period of the sustain period so as to equalize the numbers of sustain discharges in the discharge cells C(2i−1, j) and C(2i, j) on the first and second display lines L₂ᵢ₋₁ and L₂ᵢ. That is, while the Vs voltage is applied to the first group Xᵢ of the X electrodes during the second period of the sustain period, the discharge cell C(2i, j) on the second display line L₂ᵢ is sustain-discharged by applying the 0V to the second group Xᵢ₊₁ of the X electrodes and the Vs voltage to the Y electrode Yᵢ and after the discharge cell C(2i, j) is sustain-discharged again by applying the Vs voltage to the second group Xᵢ₊₁ of the X electrodes and the 0V to the Y electrode Yᵢ. Then, the numbers of sustain discharges in the discharge cells C(2i−1, j) and C(2i, j) on the first and second display lines L₂ᵢ₋₁ and L₂ᵢ are equalized. In one embodiment, a voltage (e.g., a voltage of (VscH−VscL)) that does not cause the sustain discharge between the X and Y electrodes may be applied to the first group Xi of the X electrodes instead of the Vs voltage during the second period of the sustain period. In one embodiment, the voltages applied to the first group of the X electrodes and the voltages applied to the second period of the X electrodes may be reversed to each other by a frame instead of performing the second period in the sustain period.

Next, driving waveforms of the plasma display device, applied when the discharge cell C(2i−1, j) on the first display line L₍₂ᵢ₋₁₎ among the two discharge cells C(2i−1, j) and C(2i, j) is selected as the turn-on cell as shown in FIG. 4A, will now be described with reference to FIG. 3B.

As shown in FIG. 3B, the discharge cell C(2i−1, j) on the first display line L₂ᵢ₋₁ is selected as the turn-on cell due to the Va voltage to applied to the A electrode Aⱼ and the VscL voltage applied to the Y electrode Yᵢ during the first period of the address period, but the discharge cell C(2i, j) on the second display line L₂ᵢ is not selected as the turn-on cell during the second period of the address period because the reference voltage is applied to the A electrode Aⱼ when the VscL voltage is applied to the Y electrode Yⱼ. Then, in the discharge cell C(2i, j) on the second display line L₂ᵢ the address discharge and the sustain discharge are not generated during the address period and the sustain period. That is, the address discharge is generated during the first period of the address period in the discharge cell C(2i−1, j) on the first display line L₍₂ᵢ₋₁₎. In addition, during the wall charge compensation period and the sustain period, the sustain discharge is generated in the discharge cell C(2i−1, j) on the first display line L_{(2i-1).}

Next, driving waveforms of the plasma display device, applied when the discharge cell C(2i, j) on the second display line L₂ᵢ among the two discharge cells C(2i−1, j) and C(2i, j) is selected as the turn-on cell as shown in FIG. 4B, will now be described with reference to FIG. 3C.

As shown in FIG. 3C, the discharge cell C(2i, j) on the second display line L₂ⱼ is selected as the turn-on cell due to the Va voltage applied to the A electrode Aⱼ and the VscL voltage applied to the Y electrode Yᵢ during the second period of the address period, but the discharge cell C(2i−1, j) on the first display line L₂ᵢ is not selected as the turn-on cell during the period of the address period because the reference voltage is applied to the A electrode Aⱼ when the VscL voltage is applied to the Y electrode Yⱼ. Then, the address discharge is generated in the discharge cell C(2i, j) on the second display line L₂ᵢ during the second period of the address period. In the discharge cell C(2i−1, j) on the first display line L₍₂ᵢ₋₁₎, the address discharge and the sustain discharge are not generated during the address period and the sustain period. Since the address discharge is not generated during the first period of the address period as described above, the wall charge states of the discharge cells C(2i−1, j) and C(2i, j) are the same as the wall charge state when the reset period ends. Accordingly, no discharge is generated in the discharge cells C(2i−1, j) and C(2i, j) during the wall charge compensation period, the wall charge state of the discharge cells C(2i−1, j) and C(2i, j) when the wall charge compensation period ends is the same as the wall charge state when the reset period ends. Therefore, the address discharge is stably generated during the second period of the address period.

In addition to the PDP 100 shown in FIG. 2, the driving waveforms in FIG. 3A to FIG. 3C may be applied to the PDP 100 shown in FIG. 6.

FIG. 6 shows another exemplary embodiment of electrode arrangement diagram of the PDP 100′.

Differently from the electrode arrangement shown in FIG. 2, the respective display lines are defined by the respective Y and X electrodes as shown in FIG. 6. That is, one X electrode may define one display line, which is located at the lower side of the X electrode, together with one Y electrode, and one Y electrode also may define one display line, which is located at the upper side of the Y electrode, together with one X electrode. To apply the driving waveforms to a plurality of Y electrodes Y₁ to Yₙ shown in FIG. 6 in a like manner shown in FIG. 3A to FIG. 3C, the plurality of Y electrodes Y₁ to Y₁ are divided into a first group including odd-numbered Y electrodes Y₁, Y₃, . . . , and Y₍ₙ₋₁₎ and a second group including even-numbered Y electrodes Y₂, Y₄, . . . , and Yₙ. In one embodiment, the second group may include the odd-numbered Y electrodes Y₁, Y₃, . . . , and Y₍ₙ₋₁₎ and the first group may include the even-numbered Y electrodes Y₂, Y₄, . . . , and Yₙ. One Y electrode (e.g., Y₁) of the first group and one Y electrode (e.g., Y₂) of the second group form one of the plurality of scan lines to which the scan pulse is sequentially applied during each of the first and second periods of the address period. In addition, display lines L, to L₍₂ₙ₋₁₎ include a plurality of first display lines defined by the first group of the Y electrodes and the first group of the X electrodes, and a plurality of second display lines defined by the second group of the Y electrodes and the second group of the X electrodes. Therefore, each of the scan lines is shared by corresponding one of the first display lines and corresponding one of the second display lines.

In addition, one portion of barrier ribs 34 extending in the column direction may be formed between two adjacent A electrodes and the other portion of the barrier ribs 34 extending in the row direction may be formed between two adjacent display lines. Each of the X electrodes X₁ to X₁ and each of the Y electrodes Y₁ to Yₙ respectively include bus electrodes 31a and 32a. In contrast to FIG. 2, they include transparent electrodes 31b and 32b extending toward the corresponding discharge cells 33 from the bus electrodes 31a and 32a. In one embodiment, the X electrodes X₁ to Xₙ and the Y electrodes Y₁ to Yₙ may be formed by only the bus electrodes 31a and 32a.

According to at least one embodiment of the present invention, a scan line is shared by two display lines such that the number of scan circuits may be reduced. In addition, the address period includes the first period for selecting the first discharge cell defined by the plurality of first display lines and the second period for selecting the plurality of second discharge cells defined by the plurality of second display lines, and the wall charge compensation period for compensating the wall charges of the plurality of second discharge cells is formed between the first period and the second period. Therefore, when the first discharge cell and the second discharge cell are selected as the turn-on cells, the address discharge may be stably performed.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of driving a plasma display device, the method comprising:
selecting a first turn-on cell from a plurality of first discharge cells during a first period of an address period, wherein the first discharge cells are defined by a plurality of first display regions and a plurality of address electrodes, wherein each of the first display regions extends in a first direction, and wherein each of the address electrodes extends in a second direction crossing the first direction;
selecting a second turn-on cell from a plurality of second discharge cells during a second period of the address period, wherein the second discharge cells are defined by a plurality of second display regions and the address electrodes, wherein each of the second display regions extends in the first direction; and
sustain-discharging the first turn-on cell during a third period between the first and second periods of the address period,
wherein two adjacent first and second display regions share one of a plurality of scan lines, and wherein each of the scan lines extends in the first direction.

2. The method of claim 1, wherein the sustain-discharging comprises compensating wall charges of at least one of the second discharge cells, and
wherein the first turn-on cell and the at least one of the second discharge cells share one of the scan lines and one of the address electrodes.

3. The method of claim 1, wherein the sustain-discharging comprises discharging at least one of the second discharge cells,
wherein the first turn-on cell and the at least one of the second discharge cells share one of the scan lines and one of the address electrodes,
and wherein the intensity of the discharging at the at least one second discharge cell is less than that of the sustain-discharging at the first turn-on cell.

4. The method of claim 1, further comprising,
sustain-discharging the first and second turn-on cells during a first period of a sustain period; and
further sustain-discharging the second turn-on cell during a second period of the sustain period.

5. The method of claim 4, wherein the first turn-on cell is not sustain-discharged during the further sustain-discharging.

6. The method of claim 4, wherein the plasma display device further comprises a plurality of sustain electrodes including a first group of sustain electrodes and a second group of sustain electrodes,
wherein each of the first display regions is defined by a corresponding one of the first group and a corresponding one of the scan lines,
and wherein each of the second display regions is defined by a corresponding one of the second group and a corresponding one of the scan lines.

7. The method of claim 6, wherein the plasma display device further comprises a plurality of scan electrodes respectively defining the plurality of scan lines,
wherein the sustain electrodes and the scan electrodes are formed so as to alternate with each other.

8. The method of claim 6, wherein the plasma display device further comprises a plurality of scan electrodes respectively corresponding to the plurality of sustain electrodes,
wherein the scan electrodes comprise a third group of scan electrodes and a fourth group of scan electrodes, and each of the scan lines includes a corresponding one of the third group and a corresponding one of the fourth group.

9. The method of claim 6, further comprising
applying a first voltage and a second voltage to the address electrodes and the second group, respectively, during the third period,
wherein the applying comprises:
applying a third voltage, which is lower than the second voltage, to the first group and applying a fourth voltage, which is higher than the third voltage, to the scan lines, during a first sub-period of the third period; and
applying a fifth voltage, which is lower than the fourth voltage and is higher than the third voltage, to the first group and applying the third voltage to the scan lines, during a second sub-period of the third period.

10. The method of claim 9, further comprising:
during the first period of the scan period, applying the second voltage to the first group and applying the third voltage to the second group;
during the second period of the scan period, applying the third voltage to the first group and applying the second voltage to the second group;
sequentially applying a first scan pulse to the scan lines during the first period of the address period; and
sequentially applying a second scan pulse to the scan lines during the second period of the address period.

11. The method of claim 10, wherein the plasma display device further comprises a plurality of scan electrodes respectively corresponding to the plurality of sustain electrodes,
and wherein the method further comprises:
during the first period of the sustain period, alternately applying the fourth voltage and the third voltage to the scan lines and the sustain electrodes; and
during the second period of the sustain period, alternately applying the fourth voltage and the third voltage to the scan electrodes and the second group while the fourth voltage is being applied to the first group.

12. The method of claim 6, further comprising
initializing the plurality of first discharge cells and the plurality of second discharge cells to be in a turn-off cell state during a reset period.

13. The method of claim 6, wherein one of the first and second groups comprises odd-numbered sustain electrodes, and the other group comprises even-numbered sustain electrodes.

14. A plasma display device, comprising:
a plasma display panel (PDP) comprising i) a plurality of first display regions, ii) a plurality of second display regions, iii) a plurality of address electrodes, iv) a plurality of first discharge cells defined by the first display regions and the address electrodes, and v) a plurality of second discharge cells defined by the second display regions and the address electrodes, wherein two adjacent first and second display regions share one of a plurality of scan lines, wherein each of the first display regions and each of the second display regions extend in a first direction, and wherein each of the address electrodes extends in a second direction crossing the first direction; and
a driver configured to select a first turn-on cell from the first discharge cells during a first period of an address period, select a second turn-on cell from the second discharge cells during a second period of the address period, and sustain-discharge the first turn-on cell during a third period between the first period and the second period.

15. The plasma display device of claim 14, wherein the driver is further configured to sustain-discharge the first and second turn-on discharge cells during a first period of a sustain period, and further sustain-discharge the second turn-on cell during a second period of the sustain period.

16. The plasma display device of claim 14, further comprising a plurality of sustain electrodes including a first group of sustain electrodes and a second group of sustain electrodes,
wherein each of the first display regions is defined by a corresponding one of the first group and a corresponding one of the scan lines, and each of the second display regions is defined by a corresponding one of the second group and a corresponding one of the scan lines,
wherein the driver is further configured to respectively apply a first voltage and a second voltage to the address electrodes and the second group during the third period,
apply a third voltage, which is lower than the second voltage, to the first group and apply a fourth voltage, which is higher than the third voltage, to the scan lines, during a first sub-period of the third period, and
apply a fifth voltage, which is lower than the fourth voltage and is higher than the third voltage, to the first group and apply the third voltage to the scan lines, during a second sub-period of the third period.

17. The plasma display device of claim 16, wherein the driver is further configured to: i) apply the second voltage to the first group and apply the third voltage to the second group during the first period of the address period,
ii) apply the third voltage to the first group and apply the second voltage to the second group during the second period of the address period, iii) sequentially apply a first scan pulse to the scan lines during the first period of the address period, and
iv) apply a second scan pulse to the scan lines during the second period of the address period.

18. The plasma display device of claim 14, wherein the driver is further configured to gradually decrease voltages at the plurality of scan lines to initialize the first discharge cells and the second discharge cells during a reset period.
